(19) United States
(12) Patent Application Publication
(10) Pub. No.: US 2021/0124972 A1
(43) Pub. Date: Apr. 29, 2021

(54) OPTICAL CHARACTER RECOGNITION SYSTEM AND METHOD

(71) Applicant: Prescient Technologies Inc., Costa Mesa, CA (US)

(72) Inventors: Xingwei Liu, Irvine, CA (US); Xiaohui Xie, Irvine, CA (US); Weicheng Yu, Irvine, CA (US)

(21) Appl. No.: 17/084,543

(22) Filed: Oct. 29, 2020

Related U.S. Application Data
(60) Provisional application No. 62/927,575, filed on Oct. 29, 2019.

(51) Int. Cl. G06K 9/34; G06K 9/62; G06F 40/109; G06K 9/32

(52) U.S. Cl. CPC G06K 9/344; G06K 9/32; G06F 40/109; G06K 9/6256

(57) ABSTRACT

An optical character recognition (OCR) system disclosed herein may include three major parts: Training Data Generator, Training Module and main OCR module. The Training Data Generator may include an arbitrarily large library of fonts, a set of variable font parameters, such as font size and style (e.g., bold, italic, etc.), and position in the synthesis image. Additionally, an end-to-end training pipeline allows the OCR algorithm to be highly customizable and scalable to different scenarios. Furthermore, the OCR system can be effectively trained without any real-world training data.

### CROSS-REFERENCE TO RELATED APPLICATIONS

This application claims the benefit of U.S. Provisional application Ser. No. 16/927,575, filed Oct. 29, 2019, which is hereby incorporated by reference, to the extent that it is not conflicting with the present application.

### BACKGROUND OF INVENTION

### 1. Field of the Invention

The invention relates generally to generating training data and using the generated training data to train OCR algorithms for screen text recognition.

### 2. Description of the Related Art

Recognizing small text on a low-resolution legacy computer display is very difficult. Further, building a customized solution for every use case scenario can be time-consuming.

In addition, most existing OCR algorithms require lots of training data in order for models to perform on a specific use-case.

For example, Google™ has developed an OCR library called Tesseract™. While it appears to work well on some general OCR tasks, it did not appear to work well for a specific scenario that was encountered, i.e., recognizing small text on a low-resolution legacy computer display of a hospital.

Therefore, there is a need to solve the problems described above by providing an OCR system that can be easily trainable and scalable as well as effective in specific environments.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description.

In an aspect, a Long Short-Term Memory (LSTM) neural network is used to predict and recognize characters in each image.

In another aspect, an end-to-end training pipeline is provided that makes the OCR algorithm highly customizable and scalable to different scenarios. To adapt the OCR system to a new use case, one only needs to expand the font library and adjust the font parameter.

In another aspect, the OCR system can be effectively trained without any real-world training data.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 is a diagram illustrating a combined system-method for optical character recognition (OCR), according to several aspects.

FIG. 2 is a flowchart illustrating the Feature Extractor (Convolutional Neural Network) element shown in FIG. 1, according to an aspect.

FIG. 3 is a flowchart illustrating the Predictor (Long Short-Term Memory Neural Network) element shown in FIG. 1, according to an aspect.

FIG. 4 illustrates an example of use of the OCR system and method from FIG. 1, according to an aspect.

FIG. 5 illustrates a prior art example for which the OCR system and method from FIG. 1 can be used.

FIG. 6 depicts an aspect of an alternative approach to the OCR system and method from FIG. 1.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components, modules, algorithms or steps that are known in the art are not shown or described if they are not necessary for the invention to be understood by one of ordinary skills in the art.

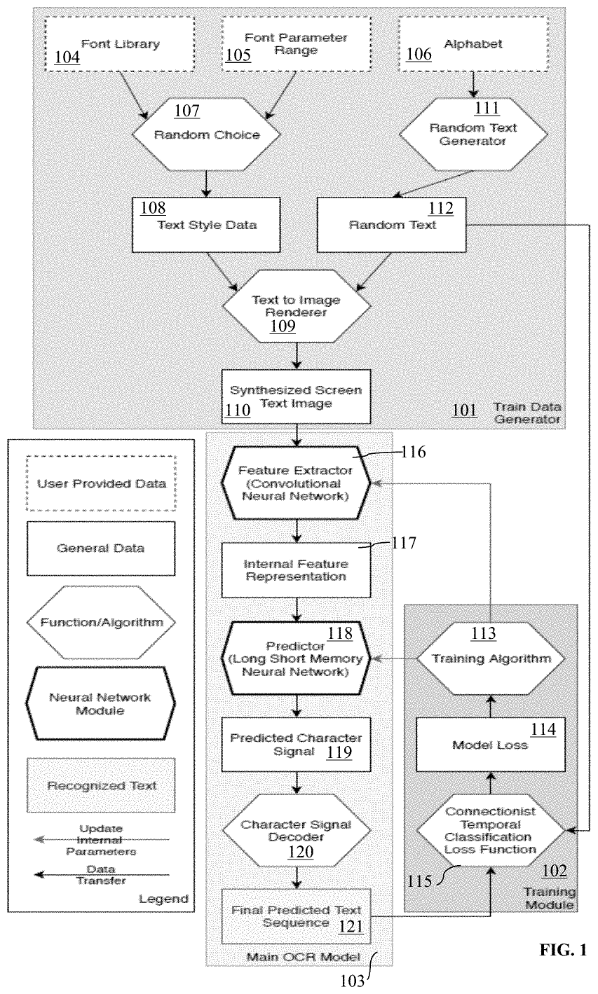

FIG. 1 is a diagram illustrating a combined system-method for optical character recognition (OCR), according to several aspects. As shown in FIG. 1, the OCR system disclosed herein may include three major parts: Training Data Generator 101, Training Module 102 and main OCR module 103. The Training Data Generator 101 may include an arbitrarily large library of fonts 104, a set of variable font parameters 105, such as font size and style (e.g., bold, italic, etc.), and position in the synthesis image. In an example, the font library 104 and the font parameters 105 can be set by a user (e.g., a programmer) directly into the code of the training data generator 101, depending on, for example, the environment in which the OCR system will be used (e.g., a hospital), and thus the type of fonts used in that environment.

As shown, the font and font parameter data 104, 105 may be used by a random choice algorithm 107 (e.g., Python™ method “random.choice”) to generate random text style data 108, by randomly selecting fonts from the font library 104 and font parameter(s) from the font parameter data 105. A user may similarly provide alphabet data 106 (e.g., alphanumeric characters), that can be used by a random text generator 111 to generate random text 112, including a single character and random sequence of characters. As an example, the random text generator 111 may generate a random number “N” from 1 to 20, which represents text length. A random character from the alphabet 106 may be selected using the random choice algorithm 107. The random character may then be appended to the currently already generated text, and a new random character from the alphabet 106 may be selected and appended until the text length comprises “N” characters, as an example.

Next, as shown in FIG. 1, the random text 112 and the text style data 108 can be fed to a text-to-image renderer 109 (e.g., Python™ Imaging Library) to produce a synthesized screen text image 110. It should be noted that this way the text-to-image renderer 109 can generate a large number (e.g., 100,000) of text images 110 that can be used to train the OCR system, as described in more detail hereinafter.

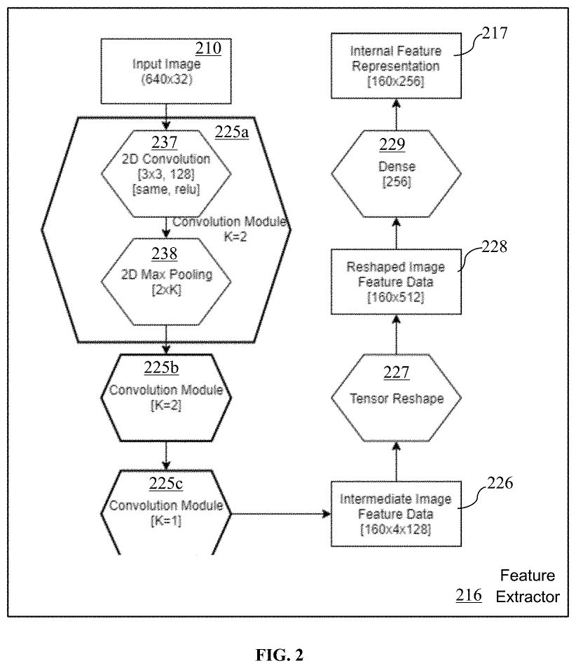

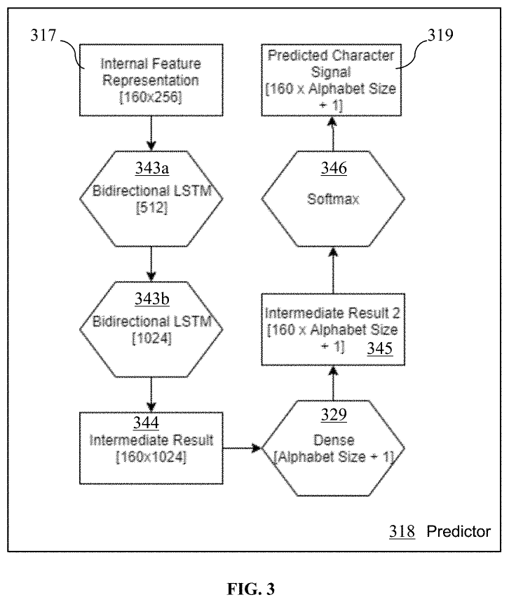

Next, the generated text image 110 may be used to train the main OCR module 103. A convolutional neural network (CNN) (“CNN,” “Feature Extractor CNN,” “Feature Extractor”) 116 may be used to extract visual information from the text image 110. The Feature Extractor 116 will be discussed in further detail when referring to FIG. 2 below. As an example, the Feature Extractor CNN 116 may convert the image 110, usually by encoding visual characteristics of the image 110, to a non-human-readable data representation of the input image 110. The Internal Feature Representation 117 represents this data. A Long Short-Term Memory neural network (LSTM) 118 may be used to predict the character signal 119 for each vertical scan line of image, which will be discussed in further detail when referring to FIG. 3.

Next, a Character Signal Decoder 120 may be provided for decoding the predicted character signal 119 and outputting readable text sequence 121. As an example, let the alphabet 106 comprise “M” characters and let the input image 110 be of size 640×32. The predicted character signal 119 may then be an (M+1)×160 matrix “S” containing decimal numbers from 0 to 1, wherein each row of the matrix corresponds to a character in the alphabet 106 in addition to a dummy empty character. This predicted character signal 119 may enter the Character Signal Decoder 120. As part of the example, the predicted character signal 119 may be decoded as follows. A sequence “O” may be constructed starting as empty. The current column number of the matrix “S” being processed may be labeled “i” (starting from 1). The row number “j” is located such that S[j, i] is the maximum number among all S[*, i]. If “j” is the same as the current last element of “O,” the function does nothing; otherwise, the function appends “j” to “O.” The function increments “i” by 1. The preceding steps are repeated until “i” reaches 160, per the example. The function then removes all dummy empty characters in “O.” Each element in “O” is converted to its corresponding character until the text has been completely decoded, as represented by the final predicted text sequence 121.

As shown in FIG. 1, the Training Module 102 may include a Connectionist Temporal Classification (CTC) Loss Function module 115 that can generate model loss data 114 that can be used by a training algorithm 113 to give the LSTM and CNN neural networks 118, 116 feedback on the correctness of the OCR prediction. The CTC Loss Function module 115 is well-known and may be selected from existing open source libraries (e.g., “torch.nn.CTCLoss” from PyTorch, “tf.nn.ctc_loss” from TensorFlow). The training algorithm 113 used to train the OCR system disclosed herein is Adam Optimizer provided by TensorFlow, which may be represented by the function “tf.train.AdamOptimizer”.

It should be noted that when training the OCR system disclosed herein, one needs to first provide proper parameter 105 and font library 104, which depends, as indicated hereinabove, on the desired use case, to the Training Data Generator 101, and use the generated image 110 to train the main OCR module 103 for a large number of images (e.g., 5 million images).

FIG. 2 is a flowchart illustrating the Feature Extractor (Convolutional Neural Network) element 216 shown in FIG. 1, according to an aspect. As shown, the Feature Extractor 216 may comprise several modules that function in a successive manner. As discussed previously when referring to FIG. 1, an input image 210 may be received by the Feature Extractor 216 and the image 210 may be converted to a non-human-readable internal feature representation 217.

As shown, the input image 210 may pass through a series of Convolution Modules 225. Each convolution module 225 may comprise a couple of modules (237 and 238) taken from the TensorFlow library, as an example. As the input image 210 enters the Convolution Module 225a, the image 210 enters a 2D Convolution module 237, as shown. The 2D Convolution module 237 may be represented by the function “tf.nn.conv2d”. As shown as an example, the 2D Convolution module 237 may be provided with specified input parameters “[3×3, 128]” and “[same, relu]”. The [3×3, 128] parameter indicates that the module 237 has a 3×3 kernel size and 128 kernels. The [same, relu] parameter indicates that the convolution output will be padded to the same 2D size of the input 210 and the output will be passed through the activation function ReLU (“tf.nn.relu” in TensorFlow). The activation function ReLU outputs the value of the input if it is positive, otherwise, the function outputs zero, as an example.

The output of the 2D Convolution module 237 may then pass into a 2D Max Pooling module 238, as shown. The 2D Max Pooling module 238 may be represented by the function “tf.keras.layers.maxpool2d”. As shown as an example, the 2D Max Pooling module 238 may be provided with specified input parameter “[2×K],” which indicates that the module has a 2×K kernel size, where “K” is a user-specified compression ratio input for each Convolution Module 225, as shown. The output of the 2D Max Pooling module 238 may pass from the Convolution Module 225a to a second Convolution Module 225b. The input to the Convolution Module 225b may pass through the same TensorFlow modules described herein above (237 and 238) and pass through a third Convolution Module 225c. The output of the Convolution Module 225c may be represented as Intermediate Image Feature Data 226, as shown.

As shown in FIG. 2, the Intermediate Image Feature Data 226 may pass into a TensorFlow module Tensor Reshape 227. The Tensor Reshape module 227 may be represented by the function “tf.reshape,” which reshapes a multidimensional data array input tensor. As an example, the Tensor Reshape module 227 may output a tensor that has the same values and shape as indicated by the input. As shown as an example in FIG. 2, the Intermediate Image Feature Data 226 may enter the Tensor Reshape module 227 with values and shape of 160×4×128 and may leave the module 227 as Reshaped Image Feature Data 228 with values and shape of 160×512. The Reshaped Image Feature Data 228 may then pass into a Dense module 229, as shown. The Dense module 229 may be represented by the TensorFlow function “tf.layers.dense”. As shown, the Dense module 229 may be provided with an input parameter “[256],” which indicates that the module 229 will output a signal containing 256 channels. As an example, the Reshaped Image Feature Data 228 may enter the Dense module 229 with values and shape of 160×512 and may leave the module 229 as Internal Feature Representation 217 with values and shape of 160×256, as shown. The Internal Feature Representation 217 represents the output of the Feature Extractor CNN 216, as shown.

It should be noted that for the CNN model 216 disclosed herein above the structure and number of Convolution Modules 225 are flexible, as long as the final output is kept a 2D matrix without over-compressing the image width. The final output is compressed four times in the given example shown in FIG. 2 (indicated by the product of all K values in FIG. 2). The larger the compression ratio K, the harder it is for the system to recognize smaller font sizes while still maintaining efficient system performance.

FIG. 3 is a flowchart illustrating the Predictor (Long Short-Term Memory Neural Network) element 318 shown in FIG. 1, according to an aspect. As shown, the LSTM neural network 318 may be provided with a number of modules taken from the TensorFlow open source library. As discussed previously when referring to FIG. 1, an Internal Feature Representation 317 may be received by the Predictor LSTM 318 and each vertical scan line of the representation 317 may be used to predict the character signal 319.

As shown, the Internal Feature Representation 317 may pass through a couple of Bidirectional LSTM modules 343. The Bidirectional LSTM module 343, which may be represented by the function “tf.keras.layers.Bidirectional(tf.keras.layers.LSTM),” may run the input in two ways (e.g., past to future and future to past) and preserves information about the input from these two ways, as is known to one of ordinary skill in the art. As shown, the Bidirectional LSTM module 343 may be provided with an input parameter controlling the number of output channels. As an example, Bidirectional LSTM 343a will output data with 512 channels, as indicated. As shown in FIG. 3, once the Internal Feature Representation 317 passes through both Bidirectional LSTM modules 343a, 343b, an Intermediate Result 344 may be output of Bidirectional LSTM module 343b with 1024 channels, as an example.

Next, the Intermediate Result 344 may pass into the Dense module 329, which was previously discussed when referring to FIG. 2. The Dense module 329 may be provided with an input parameter “[Alphabet Size+1],” which specifies that the output will contain Alphabet Size+1 total channels. The output, which is represented by Intermediate Result 2 345, may now comprise the values and shape 160×(Alphabet Size+1), as shown as an example. As shown, the Intermediate Result 2 345 may enter a Softmax module 346, which may be taken from the TensorFlow library. The Softmax module 346, which may be represented by the function “tf.nn.softmax,” may convert the final output to the probability density function of characters 319, as shown.

As an example of operation of the main OCR system 103 shown in FIG. 1, let the input data (i.e., image 210 in FIG. 2) have a size of 640×32 pixels. The Feature Extractor CNN (shown by 216 in FIG. 2) may convert the input image 210 into an Internal Feature Representation 217 having a size of 160×256 pixels. Thus, each vertical line in the 160×256 Internal Feature Representation 217 corresponds to a 4-pixel wide vertical line in the original input image 210. For each vertical line in the 160×256 Internal Feature Representation 217, the LSTM neural network (shown by 318 in FIG. 3) may predict the character each line belongs to. As an example, let the Alphabet Size parameter discussed and shown in FIG. 3 be equal to 36. Thus, if there are 36 different characters to be recognized, the LSTM neural network will output 160×37 (36+1 null character) numbers between 0 and 1. The predicted character signal 160×37 represents the probability of each character at each horizontal position, per this example. The predicted character signal may then be received and decoded by the Character Signal Decoder (shown by 120 in FIG. 1) and outputted as the final predicted text sequence (i.e. readable text).

In an example, to use the OCR system disclosed herein, one needs to provide an image containing screen text for recognition processing (see e.g., FIG. 4). The user may select (via cursors) an area of arbitrary size M by N in the image containing the text to be read. After the selection is made by the user, the OCR software crops the image according to the selection area of size M×N. The OCR software then resizes the cropped M×N image to be of size 640×32, which is provided to the main OCR system as input. It should be noted that the rescaling of the cropped image to 640×32 pixels is arbitrary and only significant to the functioning of the OCR system disclosed herein as designed. Then, the selected image can be processed by the OCR software to get the recognition result, i.e., readable text 432 and 433 in FIG. 4 which has been automatically copied to the computer's clipboard. The user may then paste the recognized copied text into a different document or webpage, as an example. In another example, when the readable text 432 is the patient ID number, the readable text 432 can be used by the OCR system disclosed herein to customize a web link that can send the user (e.g., a doctor) to the online medical record of that patient.

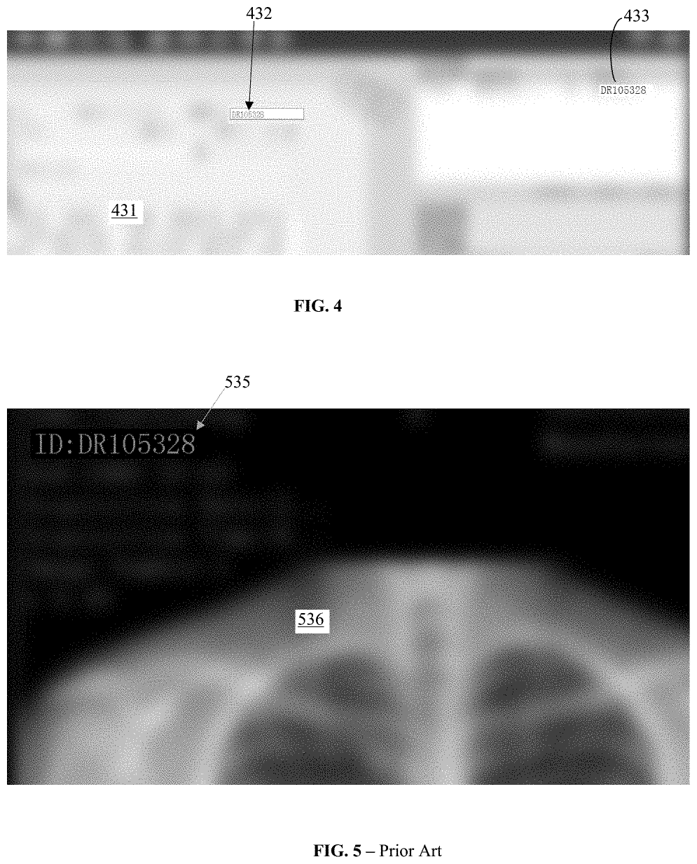

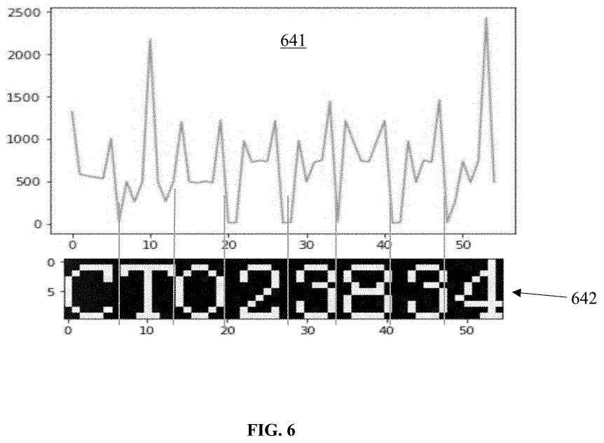

As suggested in FIG. 4, the OCR system disclosed herein can be particularly useful when using a computer system (e.g., an old computer system in a hospital) that has low-resolution screens 431 and/or lacks a copy and paste function because of the old operating systems used, for example. Similarly, as suggested in FIG. 5, the OCR system disclosed herein can be used when there is a need to extract text (e.g., patient ID 535) from an image (e.g., patient X-ray 536).

It should be noted from this disclosure that the improved OCR system has several advantages. Firstly, the OCR system can be effectively trained without any real-world training data. Most existing OCR algorithms require a lot of real-world training data in order for models to perform on a specific use-case. The OCR system and method disclosed herein does not require any real-world training data (i.e., no real text images are needed for training purposes). The OCR system and method can be effectively trained using solely the randomly generated text consisting of fonts and alphabet characters, as was previously discussed when referring to FIG. 1.

Secondly, the OCR software disclosed herein is highly scalable. To adapt it to a new use case or environment, one only needs to expand the font library 104 and adjust the generation parameter 105, as shown in FIG. 1. The model can be easily modified based on character traits in the input images specific to that environment or use, such as fonts, sizes, etc. This is very important because of the uncertainty in the actual environment that the program would be run in. The training data generator program 101 addresses this uncertainty by generating training and test data with alphanumeric content specific to the particular use.

Thirdly, the OCR software disclosed herein, offers an easy trade-off between accuracy and generality. The more characters and fonts included in the text generation process, the more general the final model is. The fewer characters and/or fonts included in the text generation process, the more accurate the final model is. In an example, when the OCR software model is purposefully designed to have limited ability to recognize text, it may decrease accuracy if the model is adapted to recognize too many different styles of text. For example, if the model can only recognize 14-size Times New Roman characters, it may do so with 100% accuracy. However, if the model is adapted to recognize 50 different fonts of all different sizes from 5 to 32, it may only be able to recognize 80% of the text correctly, as an example.

The OCR software disclosed herein showed positive testing results. The OCR software was deployed in a hospital's devices and achieved more than 95% accuracy in recognizing patient IDs in the low-resolution hospital operation system, while Tesseract™, the Google's OCR framework, could only achieve less than 80% accuracy.

FIG. 6 depicts an aspect of an alternative approach to the OCR system and method from FIG. 1. In a particular environment where the characters in the text image are sufficiently spaced apart, character segmentation based on traditional computer vision algorithms may be employed, to segment each character in text 642 into a single character block, as shown in FIG. 6. Based on the histogram 641 along image height, the segmentation algorithm can identify the gap between characters and separate them.

While described herein in connection with use of the OCR system and method in a hospital environment, it should be understood that the OCR system and method disclosed herein can similarly be used in other environments.

It may be advantageous to set forth definitions of certain words and phrases used in this patent document. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of” respectively, are closed or semi-closed transitional phrases.

Throughout this description, the aspects, embodiments or examples shown should be considered as exemplars, rather than limitations on the apparatus or procedures disclosed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples.

What is claimed is:

1. An optical character recognition system comprising a training data generator, a training module and a main OCR module, wherein the training data generator includes an arbitrary library of fonts, a set of variable font parameters, and position in the synthesis image.
